(19) United States
(12) Patent Application Publication
(10) Pub. No.: US 2018/0144291 A1
(43) Pub. Date: May 24, 2018

(54) ORDER RETRIEVAL COORDINATION SYSTEM

(71) Applicant: Wal-Mart Stores, Inc., Bentonville, AR (US)

(72) Inventors: Bruce W. Wilkinson, Rogers, AR (US); Todd D. Mattingly, Bentonville, AR (US); Brian G. McHale, Chadderton Oldham (GB); Balaraman Kirthigaivasan, Bentonville, AR (US)

(21) Appl. No.: 15/816,732

(22) Filed: Nov. 17, 2017

Related U.S. Application Data
(60) Provisional application No. 62/423,893, filed on Nov. 18, 2016.

(51) Int. Cl. G06Q 10/08

(52) U.S. Cl. CPC G06Q 10/087; G06F 21/6245

(57) ABSTRACT

In some embodiments, apparatuses and methods are provided herein useful to retrieval of orders for a group of people. In some embodiments, a system comprises a data structure, wherein the data structure includes retrieval permissions and a control circuit configured to receive, from a plurality of people, orders, receive, from a first person of the plurality of people, a request to retrieve the orders, determine, based on the data structure, that the first person is authorized to retrieve the orders associated with the one or more of the plurality of people, make available, to the first person, the orders, after the first person retrieves the orders, charge each of the one or more people of the plurality of people based on the orders, and transmit, to each of the one or more people of the plurality of people, an indication that the orders have been retrieved.

### CROSS-REFERENCE TO RELATED APPLICATION

This application claims the benefit of U.S. Provisional Application No. 62/423,893, filed Nov. 18, 2016, which is incorporated by reference in its entirety herein.

### TECHNICAL FIELD

This invention relates generally to shopping and, more specifically, to systems that improve shopping experiences.

### BACKGROUND

In traditional shopping systems (e.g., brick-and-mortar retail stores and online shopping), customers must either go to the brick-and-mortar retail store to retrieve products or wait for products to be delivered to their homes. Many customers find it inconvenient to visit a brick-and-mortar retail store to retrieve products. Additionally, some customers may not want to wait for products to be delivered, and some products may be difficult or impractical to deliver. Consequently, new systems and methods for providing goods to customers are desired.

### BRIEF DESCRIPTION OF THE DRAWINGS

Disclosed herein are embodiments of systems, apparatuses and methods pertaining system for coordinating retrieval of orders for a group of people. This description includes drawings, wherein:

FIG. 1 is a diagram depicting coordination of product retrieval for a group of people 102, according to some embodiments;

FIG. 2 is a block diagram depicting an example system 200 for coordinating order retrieval for a group of people, according to some embodiments; and

FIG. 3 is a flow chart depicting example operations for coordinating order retrieval for a group of people, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to coordinating retrieval of orders for a group of people. In some embodiments, a system comprises a data structure, wherein the data structure includes retrieval permissions and a control circuit in communication with the data structure, the control circuit configured to receive, from a plurality of people, orders, receive, from a first person of the plurality of people, a request to retrieve orders associated with one or more of the plurality of people, wherein the one or more of the plurality of the people includes at least one person other than the first person, determine, based on the data structure, that the first person is authorized to retrieve the orders associated with the one or more of the plurality of people, make available, to the first person, the orders associated with the one or more people of the plurality of people, after the first person retrieves the orders associated with the one or more people of the plurality of people, charge each of the one or more people of the plurality of people based on the orders associated with the one or more people of the plurality of people, and transmit, to each of the one or more people of the plurality of people, an indication that the orders associated with the one or more people of the plurality of people have been retrieved.

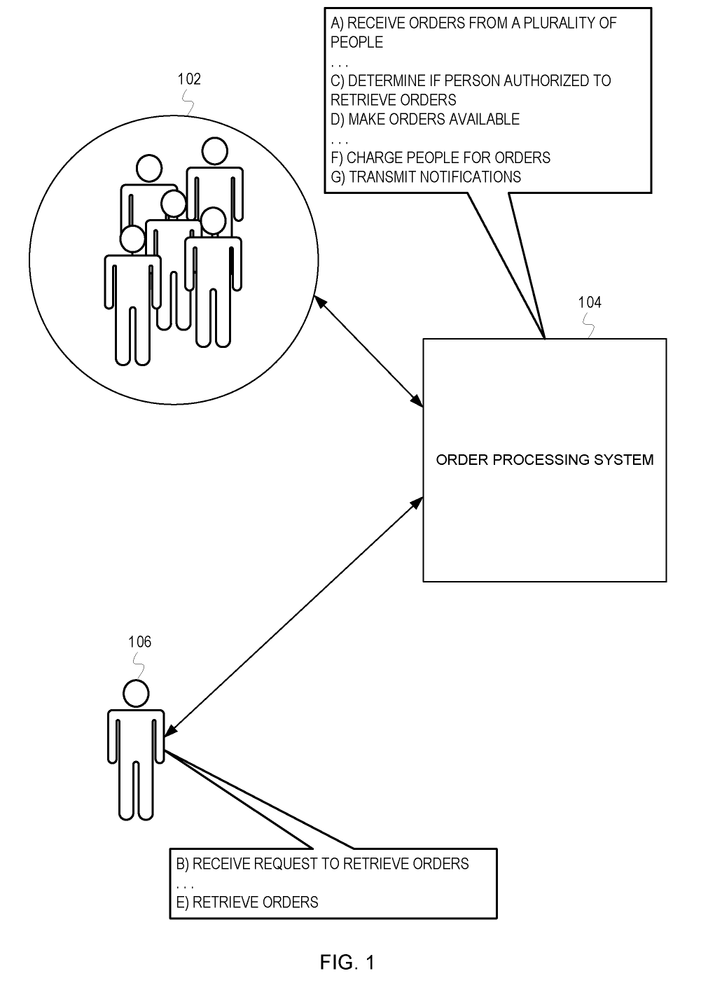

As previously discussed, customers may find it inconvenient to travel to a brick-and-mortar retail store to retrieve goods and it may be difficult or impractical to deliver some goods (e.g., perishable goods or high value goods that can be the target of theft). Embodiments of the inventive subject matter include systems, methods, and apparatuses that seek to eliminate, or at least reduce, these difficulties. In one embodiment, a system coordinates retrieval of orders for a group of people. For example, people in the group can place orders for goods (e.g., online or over the phone), the orders can be prepared, and one person (e.g., a member of the group) can retrieve the orders for all of the members of the group. The discussion of FIG. 1 provides an overview of such a system.

FIG. 1 is a diagram depicting coordination of product retrieval for a group of people 102, according to some embodiments. FIG. 1 includes example operations for coordinating product retrieval for the group of people 102. The example operations include operations between the group of people 102, a retrieving person 106, and a potential customer determination system 104. FIG. 1 depicts operations at stages A-G. These stages are examples and are not necessarily discrete occurrence over time (e.g., the operations of different stages may overlap). Additionally, FIG. 1 is an overview of example operations.

At stage A, the order processing system 104 receives orders from people in the group of people 102. The order processing system 104 can be any system suitable for receiving orders from people. As one example, the order processing system 104 can be an aggregation of servers and other computing devices that hosts websites for online shopping. In some embodiments, the group of people 102 is a predetermined group. For example, the people in the group of people 102 can form the group amongst their friends, family, neighbors, etc. and create the group and/or accounts associated with each of the people via the order processing system 104. Alternatively, or additionally, the order processing system 104 can create the group of people 102 based, for example, on the orders or characteristics of the people in the group of people 102. For example, the order processing system 104 can create the group of people 102 based on the addresses of the people in the group of people 102.

At stage B, the order processing system 104 receives a request from the retrieving person 106 to retrieve the orders. The person may or may not be a member of the group of people 102. In some embodiments, the person can request to retrieve the orders online or by contacting a store or warehouse in which the orders are located or stored.

At stage C, the order processing system determines if the retrieving person 106 is authorized to retrieve the orders. In some embodiments, formation of the group of people 102 may implicitly authorize any member of the group of people 102 to retrieve the orders. Alternatively, each person in the group of people 102 can authorize others (including those that are, and those that are not, members of the group of people 102) at the time the order is placed. In some embodiments, authorizations are stored in a data structure, such as a database or list. The order processing system 104 determines if the retrieving person 106 is authorized to retrieve the orders by accessing the data structure. The data structure can include user accounts and the user accounts can include indications of persons authorized to retrieve the orders (i.e., retrieval permissions).

At stage D, the order processing system 104 makes the orders available to the retrieving person 106. For example, the order processing system 104 can mark orders as ready for retrieval. In some embodiments, the order processing system 104 can also indicate a location in which the orders will be retrieved (e.g., in a retail store, a warehouse, a predetermined location such as an intersection or address chosen by the retrieving person 106 or the order processing system 104, etc.). In some embodiments, the orders can be placed in lockers. For example, each order can be placed in its own locker. The lockers can include wheels, handles, and other such mechanisms that aid in movement of the lockers. In some embodiments, the lockers can include locks which only the retrieving person 106 and/or the person who placed the order has the ability to open.

At sage E, the retrieving person 106 retrieves the orders. The retrieving person 106 can retrieve the orders from any suitable location. For example, the retrieving person 106 can retrieve the orders from a retail store or a warehouse. Additionally, or alternatively, the retrieving person 106, or the order processing system 104, can specify a location other than a retail store or warehouse at which the retrieving person 106 can retrieve the orders. For example, the location can be an address, intersection, place of business, etc. In some embodiments, the retrieving person 106 may have the authority to accept or refuse the orders or specific items in the orders.

At stage F, the order processing system 104 charges the people for the orders. The order processing system 104 can charge the people for the orders at the time the orders are placed, at the time the retrieving person 106 requests to retrieve the orders, or at the time the orders are retrieved. The order processing system 104 can charge the people based on payment information associated with the user accounts. In some embodiments, the user accounts are stored in the data structure.

At stage G, the order processing system 104 transmits notifications to the people that the orders have been retrieved. For example, the order processing system can transmit a notification to each person whose order has been retrieved. The notifications can be personalized or generic as to the entire group of people 102. The notifications can also indicate that the people have been charged for the order and/or an identity of the retrieving person 106.

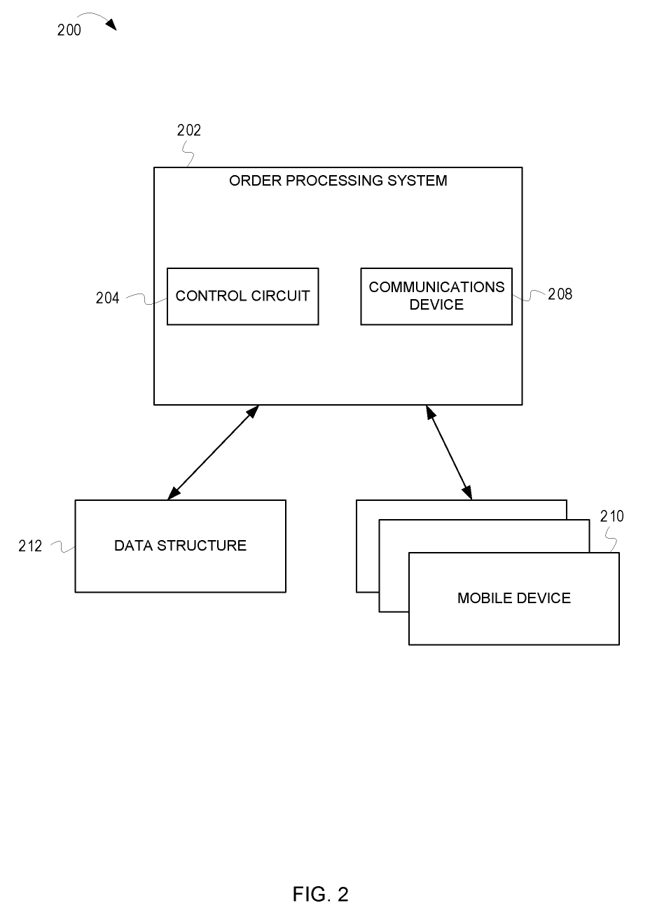

While the discussion of FIG. 1 provides an overview of a system for coordinating retrieval of orders, the discussion of FIG. 2 describes such a system in more detail.

FIG. 2 is a block diagram depicting an example system 200 for coordinating order retrieval for a group of people, according to some embodiments. The system 200 includes an order processing system 202, a data structure 212, and mobile device(s) 210. The order processing system 202 includes a control circuit 204 and a communications device 208.

The control circuit 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 202 is configured (for example, by using corresponding programming as will be well understood by those skilled in the art) to carry out one or more of the steps, actions, and/or functions described herein.

By one optional approach the control circuit 202 operably couples to a memory. The memory may be integral to the control circuit 202 or can be physically discrete (in whole or in part) from the control circuit 202 as desired. This memory can also be local with respect to the control circuit 202 (where, for example, both share a common circuit board, chassis, power supply, and/or housing) or can be partially or wholly remote with respect to the control circuit 202 (where, for example, the memory is physically located in another facility, metropolitan area, or even country as compared to the control circuit 202).

This memory can serve, for example, to non-transitorily store the computer instructions that, when executed by the control circuit 202, cause the control circuit 202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The communications device 208 can be any suitable type of communications device (e.g., modems, access points, etc.). The communications device 208 allows the order processing system 202 to receive orders from people, exchange information with the data structure 212, receive requests (e.g., from a person requesting to retrieve the orders), etc. Additionally, the communications device 208 allows the order processing system 202 to communicate with other devices that are not shown in FIG. 2 (e.g., computers, other processing systems, etc.).

The data structure 212 stores information about users and can be any suitable type of data structure. For example, the data structure 212 can store user accounts, preferences, demographic information, purchase history, group associations, authorizations, etc. Although FIG. 2 depicts the data structure 212 as being distinct from the order processing system 202, embodiments are not so limited.

The order processing system 202 can update the data structure 212 to include the user accounts, preferences, demographic information, purchase history, group associations, authorizations, etc. For example, when an order is placed, the order processing system 202 can update the data structure 202 to include an indication of the order. Additionally, the order processing system 202 can include an indication of any groups to which the customer that has placed the order belongs.

The order processing system 202 is also in communication, via the communications device 208, with the mobile devices. In embodiments in which the order processing system alerts a customer when the customer is near a pickup location at which an order for the customer, or members of group of which the customer is a part, is located, the order processing system 202 can transmit an alert to the mobile device 210 associated with the customer. The order processing system 202 can make this determination based on a geofence. For example, the mobile devices 210 can transmit indications of their locations (e.g., GPS coordinates) to the order processing system 202. When one of the mobile devices 210 is in proximity to the pickup location (e.g., when one of the mobile devices 210 has crossed a boundary of the geofence), the order processing system 202 can transmit a notification to the mobile device 210. The notification can include any relevant information, such as which items/orders are located at the pickup location, group members whose orders are at the pickup location, a time at which the orders will be ready, etc. After receiving the notification, the customer can request to retrieve the orders. When the customer requests to retrieve the orders, the mobile device 210 associated with the customer transmits the request to the order processing system 202.

In some embodiments, when a customer (i.e., a group member) requests to retrieve the orders, the order processing system 202 can update the data structure 212 to indicate that the orders are in the process of being retrieved. Additionally, once the orders are indicated as being in the process of being retrieved, the order processing system 202 can transmit notifications to other members of the group indicating that the orders are in the process of being retrieved. In such embodiments, the notification can include information such as the member of the group retrieving the items, the time the member of the group is retrieving the items, or any other relevant information.

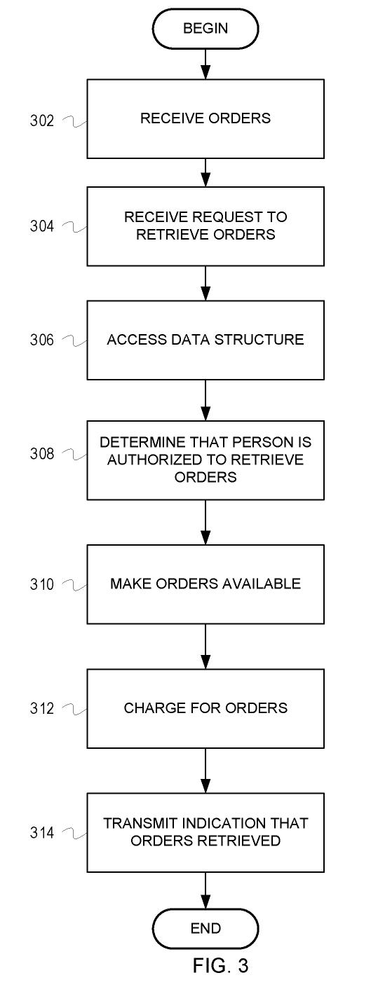

While the discussion of FIG. 2 provides additional information about system for coordinating order retrieval, the discussion of FIG. 3 details example operations for coordinating order retrieval.

FIG. 3 is a flow chart depicting example operations for coordinating order retrieval for a group of people, according to some embodiments. The flow begins at block 302.

At block 302, orders are received. For example, an order processing system can receive the orders. The orders can be placed online, over the phone, or in a store. Additionally, the orders can indicate persons authorized to retrieve the orders. For example, a person can indicate, at the time of the order, persons authorized to retrieve the order. In some embodiments, people are prompted to provide authorizations (e.g., based on previous authorizations, items in the order, a user account, etc.) at the time they place their orders. Additionally, after receiving the order and indications of authorized persons, the authorized persons can receive notifications that they have been authorized to retrieve an order. For example, the order processing system can transmit such notifications to the authorized persons. The flow continues at block 304.

At block 304, a request to retrieve the orders is received. For example, the order processing system can receive the request to retrieve the orders. The request is received from a person who would like to retrieve the orders for the group. In some embodiments, the order processing system can prompt a person to request to retrieve the orders. For example, if an authorized person is in proximity to a pickup location for the orders, the order processing system can transmit a notification to the person alerting him or her of the ability to retrieve the orders as well as his or her proximity. In response, the person can request to retrieve the orders. The flow continues at block 306.

At block 306, a data structure is accessed. For example, the order processing system can access the data structure. The data structure can include information about people (i.e., shoppers or users) such as user account information and authorization information. The authorization information may indicate people that are authorized to retrieve any order as well as people that are authorized to retrieve specific orders. For example, a first person may allow any of three people (a second person, third person, and fourth person) to retrieve general grocery orders, but may only allow one person (e.g., the third person) to retrieve pharmacy orders. The flow continues at block 308.

At block 308, it is determined that the person requesting to retrieve the orders is authorized. For example, the order processing system 308 can determine that the person is authorized. This determination can be based on the access to the data structure. For example, the order processing system can access the data structure to determine which people, if any, are authorized to retrieve the orders. The flow continues at block 310.

At block 310, the orders are made available. For example, the order processing system can make the orders available. The order processing system can make the orders available by marking the orders with an indication that they are ready to be retrieved. In some embodiments, the order processing system can cause products in the orders to be prepared for retrieval. As one example, the order processing system can cause an automated system to package the products in the orders. The products can be packaged in boxes or lockers. Further, the order processing system can make the orders available by causing the orders to be delivered to a specific location. For example, the orders can be placed at a location within a warehouse or store, or be delivered to a predetermined location (e.g., an intersection or address). The flow continues at block 312.

At block 312, the people are charged for the orders. For example, the order processing system can charge the people for the orders. The order processing system can charge the people for the orders at the time the orders are placed, at the time the retrieving person requests to retrieve the orders, or at the time the orders are retrieved. The order processing system can charge the people based on payment information associated with the user accounts. In some embodiments, the user accounts are stored in the data structure. The flow continues at block 314.

At block 314, indications that the orders have been retrieved are transmitted. For example, the order processing system can transmit indications (e.g., notifications) to the people who placed the orders that the orders have been retrieved. The notifications can be personalized or generic as to the entire group of people. The notifications can also indicate that the people have been charged for the order and/or an identity of the person who retrieved the orders.

In some embodiments, a system comprises a data structure, wherein the data structure includes retrieval permissions and a control circuit in communication with the data structure, the control circuit configured to receive, from a plurality of people, orders, receive, from a first person of the plurality of people, a request to retrieve orders associated with one or more of the plurality of people, wherein the one or more of the plurality of the people includes at least one person other than the first person, determine, based on the data structure, that the first person is authorized to retrieve the orders associated with the one or more of the plurality of people, make available, to the first person, the orders associated with the one or more people of the plurality of people, after the first person retrieves the orders associated with the one or more people of the plurality of people, charge each of the one or more people of the plurality of people based on the orders associated with the one or more people of the plurality of people, and transmit, to each of the one or more people of the plurality of people, an indication that the orders associated with the one or more people of the plurality of people have been retrieved.

In some embodiments, a method comprises receiving orders from a plurality of people, receiving, from a first person of the plurality of people, a request to retrieve orders associated with one or more people of the plurality of people, wherein the one or more of the plurality of the people includes at least one person other than the first person, accessing a data structure, wherein the data structure includes retrieval permissions of at least some of the plurality of people, determining, based on the accessing the data structure, that the first person is authorized to retrieve the orders associated with the one or more people of the plurality of people, making available, to the first person, the orders associated with the one or more people of the plurality of the people, after the first person retrieves the orders associated with the one or more people of the plurality of the people, charging each of the one or more people of the plurality of people based on the orders associated with the one or more people of the plurality of people, and transmitting, to each of the one or more people of the plurality of people, an indication that the orders associated with the one or more people of plurality of people have been retrieved.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for coordinating retrieval of orders for a group of people, the system comprising:
a data structure, wherein the data structure includes retrieval permissions; and
a control circuit in communication with the data structure, the control circuit configured to:
receive, from a plurality of people, orders, wherein the orders are associated with the plurality of people;
determine that a first person is in proximity to a pickup location for the orders associated with the one or more people of the plurality of people;
transmit, to the first person, a notification;
receive, from the first person of the plurality of people, a request to retrieve orders associated with one or more people of the plurality of people, wherein the one or more people of the plurality of people includes at least one person other than the first person;
determine, based on the data structure, that the first person is authorized to retrieve the orders associated with the one or more of the plurality of people;
make available, to the first person, the orders associated with the one or more people of the plurality of people;
after the first person retrieves the orders associated with the one or more people of the plurality of people, charge each of the one or more people of the plurality of the people based on the orders associated with the one or more people of the plurality of the people; and
transmit, to each of the one or more people of the plurality of the people, an indication that the orders associated with the one or more people of the plurality of the people have been retrieved.

2. The system of claim 1, wherein the indication that the orders associated with the one or more people of the plurality of the people have been retrieved includes an indication of the first person.

3. The system of claim 1, the control circuit further configured to:
receive, from the first person, an indication of a location to retrieve the orders associated with the one or more people of the plurality of people.

4. The system of claim 1, wherein the retrieval permissions include groups of people, wherein each person in a group authorizes others in the group to retrieve orders.

5. The system of claim 1, wherein the determination that the first person is in proximity to the pickup location is based on a geofence.

6. The system of claim 5, wherein the notification includes an indication of the orders associated with the one or more people of the plurality of people.

7. The system of claim 1, the control circuit configured to:
before each of the one or more people of the plurality of people is charged, receive, from the first person, approval of items in the orders associated with the one or more people of the plurality of people.

8. The system of claim 1, further comprising:
lockers, wherein the orders associated with the one or more people of the plurality of the people are located in the lockers, and wherein the first person retrieves the orders associated with the one or more people of the plurality of people by retrieving the lockers.

9. The system of claim 1, wherein the control circuit is further configured to:
after receipt of an order, prompt a person associated with the order for an indication or authorized persons.

10. A method for coordinating retrieval of orders for a group of people, the method comprising:
receiving orders from a plurality of people;
determining that a first person is in proximity to a pickup location for the orders associated with the one or more people of the plurality of people;
transmitting, to the first person, a notification;
receiving, from the first person of the plurality of people, a request to retrieve orders associated with one or more people of the plurality of people, wherein the one or more of the plurality of people includes at least one person other than the first person;
accessing a data structure, wherein the data structure includes retrieval permissions of at least some of the plurality of people;
determining, based on the accessing the data structure, that the first person is authorized to retrieve the orders associated with the one or more people of the plurality of people;
making available, to the first person, the orders associated with the one or more people of the plurality of people;
after the first person retrieves the orders associated with the one or more people of the plurality of the people, charging each of the one or more people of the plurality of people based on the orders associated with the one or more people of the plurality of people; and
transmitting, to each of the one or more people of the plurality of people, an indication that the orders associated with the one or more people of the plurality of people have been retrieved.

11. The method of claim 10, wherein the indication that the orders associated with the one or more people of the plurality of the people have been retrieved includes an indication of the first person.

12. The method of claim 10, further comprising:
receiving, from the first person, an indication of a location to retrieve the orders associated with the one or more people of the plurality of the people.

13. The method of claim 10, wherein the retrieval permissions include groups of people, wherein each person in a group authorizes others in the group to retrieve orders.

14. The method of claim 10, wherein the determining that the first person is in proximity to the pickup location is based on a geofence.

15. The method of claim 14, wherein the notification includes an indication of the orders associated with the one or more people of the plurality of the people.

16. The method of claim 10, further comprising:
before each of the one or more people of the plurality of people is charged, receiving, from the first person, approval of items in the orders associated with the one or more people of the plurality of people.

17. The method of claim 10, wherein the orders associated with the one or more people of the plurality of the people are located in lockers, and wherein the first person retrieves the orders associated with the one or more people of the plurality of people by retrieving the lockers.

18. The method of claim 10, further comprising:
after receipt of an order, prompting a person associated with the order for an indication of authorized persons.
